(19) United States
(12) Patent Application Publication
(10) Pub. No.: US 2006/0054435 A1
(43) Pub. Date: Mar. 16, 2006

(54) Hydraulic shock absorber

(76) Inventor: Hiroyuki Yamaguchi, Machida-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/188,623

(22) Filed: Jul. 26, 2005

(30) Foreign Application Priority Data
Jul. 27, 2004 (JP) 218699/2004

(51) Int. Cl. F16F 9/00

(52) U.S. Cl. 188/314; 188/322.19; 188/322.2

(57) ABSTRACT

A hydraulic shock absorber has a subassembled reservoir cartridge including a gas chamber and a free piston. The reservoir cartridge, a separator and a cylinder are inserted into a base shell, and an oil seal is secured to the base shell under application of a predetermined axial load, thereby fixing together these members in the axial direction. An annular hydraulic fluid passage is formed between the base shell and the reservoir cartridge, and another annular hydraulic fluid passage is formed between the base shell and the cylinder. A damping force generating mechanism is attached to a side of the base shell. Damping force is generated by supplying a hydraulic fluid sealed in the cylinder to the damping force generating mechanism through the annular hydraulic fluid passages. Stable damping force is obtained through pressurization by the gas chamber and through gas-liquid separation by the free piston.

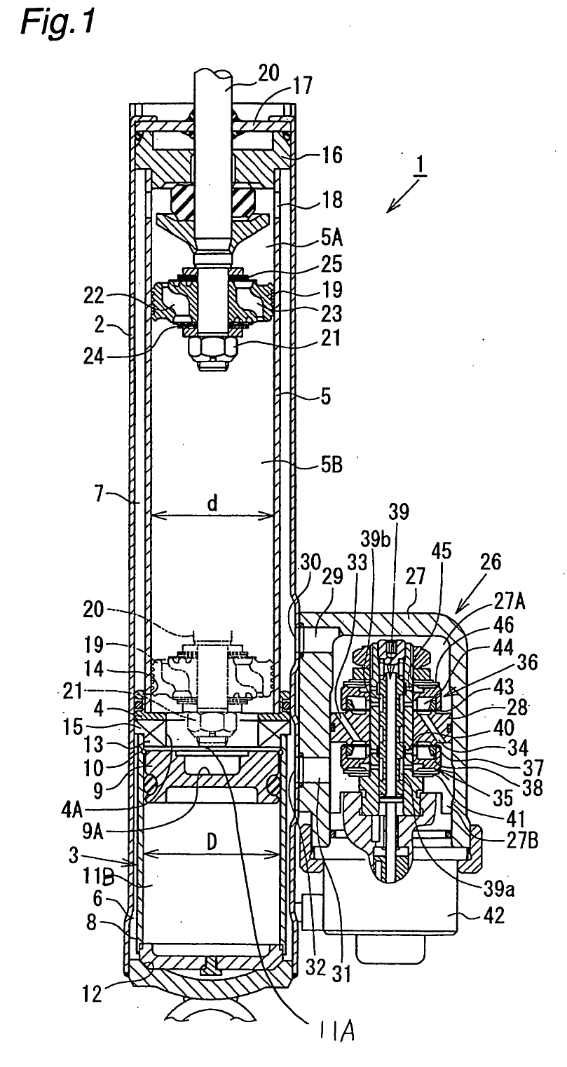

### BACKGROUND OF THE INVENTION

The present invention relates to a hydraulic shock absorber suitable for use in a suspension system of a vehicle, for example, an automobile. More particularly, the present invention relates to a hydraulic shock absorber including a reservoir tank having a hydraulic fluid chamber and a gas chamber.

In general, a cylinder type hydraulic shock absorber attached to a suspension system of a vehicle, e.g. an automobile, includes a cylinder having a hydraulic fluid sealed therein. A piston having a piston rod connected thereto is slidably fitted in the cylinder. The flow of hydraulic fluid induced by sliding movement of the piston is controlled by a damping force generating mechanism including an orifice, a disk valve, etc., thereby generating damping force. In addition, the cylinder is connected with a reservoir having the hydraulic fluid and gas sealed therein to compensate for a volumetric change in the cylinder due to extension and contraction of the piston rod (i.e. piston rod withdrawal from and entry into the cylinder) by the compression and expansion of the gas.

The above-described hydraulic shock absorber having a reservoir suffers from the problem that cavitation is likely to occur because the gas in the reservoir is at low pressure. Further, the gas (air) in the reservoir may readily get mixed in the hydraulic fluid. That is, aeration may occur easily. Thus, it is likely that the damping force will become unstable, and the response of the apparatus will be degraded.

There is known a single-cylinder type hydraulic shock absorber as one that solves the above-described problems. In this type of hydraulic shock absorber, a free piston is slidably fitted in a cylinder to form a gas chamber, and a high-pressure gas is sealed in the gas chamber to pressurize the hydraulic fluid in the cylinder by the high-pressure gas through the free piston at all times. The single-cylinder type hydraulic shock absorber can prevent cavitation and aeration through pressurization by the high-pressure gas and through gas-liquid separation by the free piston.

Japanese Utility Model Application Public Disclosure (KOKAI) No. Sho 51-129988 discloses a hydraulic shock absorber in which a gas chamber (6) and a free piston (7) are provided in an inner tube (3) prepared separately from a cylinder (1), thereby improving disassemblability and assemblability.

The present invention was made in view of the above-described circumstances. Accordingly, an object of the present invention is to provide a hydraulic shock absorber wherein a gas chamber is formed by a reservoir tank provided with a partition, e.g. a free piston, thereby obtaining stable damping force and providing improved assemblability.

### SUMMARY OF THE INVENTION

The present invention is applied to a hydraulic shock absorber including a cylinder having a hydraulic fluid sealed therein. A piston is slidably fitted in the cylinder. The piston divides the interior of the cylinder into a first chamber and a second chamber. A piston rod is connected at one end thereof to the piston to form a piston assembly. The other end of the piston rod extends through the second chamber to the outside of the cylinder. A damping force generating mechanism generates damping force by controlling the flow of hydraulic fluid induced by sliding movement of the piston in the cylinder. A reservoir tank has a hydraulic fluid chamber communicably connected to the interior of the cylinder. The reservoir tank further has a gas chamber divided from the hydraulic fluid chamber by a partition. According to the present invention, the reservoir tank is formed as a subassembled reservoir cartridge provided in a cylindrical casing. The cylinder and the reservoir cartridge are inserted in a base shell having a cylindrical shape, one end of which is closed. A first hydraulic fluid passage is formed between the outer periphery of the reservoir cartridge and the base shell. The first hydraulic fluid passage communicates with the first chamber of the cylinder. A second hydraulic fluid passage is formed between the outer periphery of the cylinder and the base shell. The second hydraulic fluid passage communicates with the second chamber of the cylinder. The first hydraulic fluid passage and the second hydraulic fluid passage are cut off from each other by a separator. A seal member is secured to the open end of the base shell, thereby fixing the reservoir cartridge and the cylinder in the axial direction. The damping force generating mechanism is attached to the outside of the base shell. The damping force generating mechanism and the cylinder are communicated with each other through the first hydraulic fluid passage and the second hydraulic fluid passage.

With the hydraulic shock absorber according to the present invention, the reservoir cartridge, the separator and the cylinder can be readily assembled to the base shell, and damping force can be generated by supplying the hydraulic fluid from the cylinder to the damping force generating mechanism through the first and second hydraulic fluid passages.

An embodiment of the present invention will be described below in detail with reference to the accompanying drawing.

### BRIEF DESCRIPTION OF THE DRAWING

The attached sole FIGURE is a vertical sectional view of a hydraulic shock absorber according to an embodiment of the present invention.

### DETAILED DESCRIPTION OF THE INVENTION

As shown in the attached FIGURE, a hydraulic shock absorber 1 according to this embodiment has a double-cylinder structure having a reservoir cartridge 3, a separator 4 and a cylinder 5 inserted into a base shell 2 having a circular cylindrical shape, one end of which is closed. An annular hydraulic fluid passage 6 (first hydraulic fluid passage) is formed between the side wall of the base shell 2 and the reservoir cartridge 3. Another annular hydraulic fluid passage 7 (second hydraulic fluid passage) is formed between the side wall of the base shell 2 and the cylinder 5. The separator 4 provides communication between the interior of the cylinder 5 and the annular hydraulic fluid passage 6. The separator 4 also cuts off communication between the hydraulic fluid passage 7, on the one hand, and, on the other, the interior of the cylinder 5 and the annular hydraulic fluid passage 6.

The reservoir cartridge 3 has a free piston 9 slidably fitted in a gas chamber casing 8 having a circular cylindrical shape, one end of which is closed. The gas chamber casing 8 is a cylindrical casing used to form a subassembled reservoir cartridge in the present invention. The free piston 9 serves as a partition dividing the interior of the gas chamber casing 8 into a hydraulic fluid chamber 11A and a gas chamber 11B. The free piston 9 is prevented from coming off from the gas chamber casing 8 by a stopper 10 fitted in an inner peripheral groove formed in the opening portion of the gas chamber casing 8. A high-pressure gas is sealed in the gas chamber 11B. Thus, a reservoir tank is constructed. The inner diameter D of the gas chamber 11B is larger than the inner diameter d of the cylinder 5. The reservoir cartridge 3 is fitted into a recess 12 formed in the bottom of the base shell 2, thereby being positioned in the radial direction with respect to the base shell 2.

The separator 4 is an annular (circular cylindrical) member that fits in the base shell 2. The separator 4 has at the lower end thereof a lower fitting portion 13 that fits in the opening portion of the gas chamber casing 8. At the upper end thereof, the separator 4 has an upper fitting portion 14 that fits around the outer periphery of the lower end portion of the cylinder 5 to position it in the radial direction. The lower fitting portion 13 is provided with a hydraulic fluid passage 15 (notches) that provides communication between the interior of the cylinder 5 and the annular hydraulic fluid passage 6.

The cylinder 5 has its lower end portion fitted in the upper fitting portion 14 of the separator 4. The upper end portion of the cylinder 5 is fitted onto a rod guide 16 fitted in the opening portion of the base shell 2. Thus, the cylinder 5 is positioned in the radial direction with respect to the base shell 2. An oil seal 17 (seal member) is fitted to the top of the rod guide 16. The oil seal 17 is secured to the base shell 2 by caulking the upper end portion of the base shell 2. The oil seal 17 seals the interior of the cylinder 5 and the annular hydraulic fluid passage 7 from the outside. A hydraulic fluid is sealed in the interior of the cylinder 5. The reservoir cartridge 3, the separator 4, the cylinder 5, the rod guide 16 and the oil seal 17 are brought into contact with one another. In this state, the oil seal 17 is secured to the base shell 2 under application of a predetermined axial load, whereby these members are fixed together in the axial direction. It should be noted that the oil seal 17 may be secured to the base shell 2 by other securing method, e.g. welding. A hydraulic fluid passage 18 is provided in the side wall of the upper end portion of the cylinder 5 to provide communication between the interior of the cylinder 5 and the annular hydraulic fluid passage 7.

A piston 19 is slidably fitted in the cylinder 5. The piston 19 divides the interior of the cylinder 5 into two chambers, i.e. a cylinder upper chamber (second chamber) 5A, and a cylinder lower chamber (first chamber) 5B. One end portion of a piston rod 20 is connected to the piston 19 with a nut 21 to form a piston assembly. The other end portion of the piston rod 20 extends through the rod guide 16 and the oil seal 17 to the outside of the cylinder 5. The free piston 9 has a recess 9A in the top thereof. When the piston rod 20 contracts to its lowermost position (see the imaginary lines in the figure), one end portion of the piston rod 20 projecting below the piston 19 and the piston nut 21 (i.e. the projecting portion of the piston assembly) are received in a central opening 4A (relief space) of the separator 4 and the recess 9A of the free piston 9.

The piston 19 is provided with an extension hydraulic fluid passage 22 and a compression hydraulic fluid passage 23 for communication between the cylinder upper and lower chambers 5A and 5B. The extension hydraulic fluid passage 22 is provided with a normally-closed relief valve 24 (disk valve) that opens when the pressure in the cylinder upper chamber 5A reaches a predetermined pressure to relieve the pressure into the cylinder lower chamber 5B. The compression hydraulic fluid passage 23 is provided with a normally-closed relief valve 25 (disk valve) that opens when the pressure in the cylinder lower chamber 5B reaches a predetermined pressure to relieve the pressure into the cylinder upper chamber 5A.

A damping force generating mechanism 26 is attached to a side portion of the base shell 2, extending over the portion of the base shell 2 where the separator 4 is fitted thereto.

The damping force generating mechanism 26 has a valve member 28 fitted and secured in a casing 27 having a circular cylindrical shape, one end of which is closed. The valve member 28 divides the interior of the casing 27 into two chambers, i.e. an upper chamber 27A, and a lower chamber 27B. The upper chamber 27A is communicated with the annular hydraulic fluid passage 7 through a hydraulic fluid passage 29 provided in the side wall of the casing 27 and through a hydraulic fluid passage 30 provided in the side wall of the base shell 2. The lower chamber 27B is communicated with the annular hydraulic fluid passage 6 through a hydraulic fluid passage 31 provided in the side wall of the casing 27 and through a hydraulic fluid passage 32 provided in the side wall of the base shell 2. The valve member 28 is provided with an extension hydraulic fluid passage 33 and a compression hydraulic fluid passage 34 for communication between the upper chamber 27A and the lower chamber 27B. The extension hydraulic fluid passage 33 is provided with an extension damping force generating mechanism 35. The compression hydraulic fluid passage 34 is provided with a compression damping force generating mechanism 36.

The extension damping force generating mechanism 35 has a main valve 37 (disk valve) that opens upon receiving the pressure of hydraulic fluid from the extension hydraulic fluid passage 33 to generate damping force. A pilot chamber 38 is provided at the back of the main valve 37 to apply the pressure in the pilot chamber 38 in a direction for closing the main valve 37. The pilot chamber 38 is communicated with the extension hydraulic fluid passage 33, which is upstream thereof, through an orifice hydraulic fluid passage (not shown). The pilot chamber 38 is also communicated with the lower chamber 27B through a spool valve 39. The spool valve (flow control valve) has a notch 39a which communicates the pilot chamber with the lower chamber 27B, which is downstream thereof, through a port 40 and a check valve 41. The spool valve 39 is moved by a solenoid actuator 42 to vary the flow path area of the port 40, thereby directly adjusting the flow path area between the upper and lower chambers 27A and 27B, and thus also adjusting the pressure in the pilot chamber 38 to control the valve opening pressure of the main valve 37.

The compression damping force generating mechanism 36 has a main valve 43 (disk valve) that opens upon receiving the pressure of hydraulic fluid from the compression hydraulic fluid passage 34 to generate damping force. A pilot chamber 44 is provided at the back of the main valve 43 to apply the pressure in the pilot chamber 44 in a direction for closing the main valve 43. The pilot chamber 43 is communicated with the compression hydraulic fluid passage 34, which is upstream thereof, through an orifice hydraulic fluid passage (not shown). The spool valve 39 is shared between the extension damping force generating mechanism 35 and the compression damping force generating mechanism 36. A notch 39b of the spool valve 39 for the compression damping force generating mechanism 36 is communicated with the upper chamber 27A, which is downstream thereof, through a port 45 and a check valve 46. The spool valve 39 is moved by the solenoid actuator 42 to vary the flow path area of the port 45, thereby directly adjusting the flow path area between the upper and lower chambers 27A and 27B, and thus also adjusting the pressure in the pilot chamber 44 to control the valve opening pressure of the main valve 43.

The following is a description of the operation of this embodiment arranged as stated above.

During the extension stroke of the piston rod 20, as the piston 19 slides in the cylinder 5, the hydraulic fluid in the cylinder upper chamber 5A flows into the upper chamber 27A of the damping force generating mechanism 26 through the hydraulic fluid passage 18, the annular hydraulic fluid passage 7, and the hydraulic fluid passages 30 and 29. The hydraulic fluid further flows from the upper chamber 27A to the lower chamber 27B through the extension hydraulic fluid passage 33. Further, the hydraulic fluid flows from the lower chamber 27B to the cylinder lower chamber 5B through the hydraulic fluid passages 31 and 32, the annular hydraulic fluid passage 6, and the hydraulic fluid passage 15. Thus, damping force is generated by the extension damping force generating mechanism 35. At this time, the high-pressure gas in the gas chamber 11B expands by an amount corresponding to the amount by which the piston rod 20 withdraws from the cylinder 5 as it extends, thereby compensating for a volumetric change in the cylinder 5.

In the extension damping force generating mechanism 35, when the piston speed is in a low speed region, damping force of orifice characteristics is generated by the orifice passage and according to the flow path area of the port 40 that is adjusted by the spool valve 39. As the piston speed rises, the main valve 37 opens to generate damping force of valve characteristics. The orifice characteristics can be adjusted by moving the spool valve 39 with the solenoid actuator 42 to thereby vary the flow path area of the port 40. In addition, the valve characteristics can be adjusted by controlling the pressure in the pilot chamber 38 through the movement of the spool valve 39 by the solenoid actuator 42. It should be noted that when the pressure in the cylinder upper chamber 5A reaches a predetermined pressure, the relief valve 24 of the piston 19 opens to relieve the pressure in the cylinder upper chamber 5A directly into the cylinder lower chamber 5B, thereby preventing an excessive rise in damping force.

During the compression stroke of the piston rod 20, as the piston 19 slides in the cylinder 5, the hydraulic fluid in the cylinder lower chamber 5B flows into the lower chamber 27B of the damping force generating mechanism 26 through the hydraulic fluid passage 15, the annular hydraulic fluid passage 6, and the hydraulic fluid passages 32 and 31. The hydraulic fluid further flows from the lower chamber 27B to the upper chamber 27A through the compression hydraulic fluid passage 34. Further, the hydraulic fluid flows from the upper chamber 27A to the cylinder upper chamber 5A through the hydraulic fluid passages 29 and 30, the annular hydraulic fluid passage 7, and the hydraulic fluid passage 18. Thus, damping force is generated by the compression damping force generating mechanism 36.

At this time, the high-pressure gas in the gas chamber 11B is compressed by an amount corresponding to the amount by which the piston rod 20 enters the cylinder 5 as it contracts, thereby compensating for a volumetric change in the cylinder 5.

In the compression damping force generating mechanism 36, when the piston speed is in a low speed region, damping force of orifice characteristics is generated by the orifice passage and according to the flow path area of the port 45 that is adjusted by the spool valve 39. As the piston speed rises, the main valve 43 opens to generate damping force of valve characteristics. The orifice characteristics can be adjusted by moving the spool valve 39 with the solenoid actuator 42 to thereby vary the flow path area of the port 45. In addition, the valve characteristics can be adjusted by controlling the pressure in the pilot chamber 44 through the movement of the spool valve 39 by the solenoid actuator 42. It should be noted that when the pressure in the cylinder lower chamber 5B reaches a predetermined pressure, the relief valve 25 of the piston 19 opens to relieve the pressure in the cylinder lower chamber 5B directly into the cylinder upper chamber 5A, thereby preventing an excessive rise in damping force.

In the present invention, the gas chamber 11B and the free piston 9 are subassembled into the reservoir cartridge 3, whereby assemblability can be improved. The reservoir cartridge 3, the separator 4 and the cylinder 5 are inserted into the base shell 2, and the rod guide 16 and the oil seal 17 are fitted into the base shell 2. Then, the oil seal 17 is secured to the base shell 2 by caulking, welding, etc. With this arrangement, the main body components of the hydraulic shock absorber 1 can be assembled easily.

At the time of assembly, the oil seal 17 can be fixed to the base shell 2 from the outside. Therefore, there is no occurrence of contamination inside the hydraulic shock absorber 1, such as sputtering during welding. Thus, it is possible to solve the problem of contamination and to improve production quality. Further, because the inner diameter D of the gas chamber 11B is larger than the inner diameter d of the cylinder 5, the stroke of the free piston 9 can be made small relative to the stroke of the piston 19. Hence, the effective stroke of the hydraulic shock absorber 1 can be increased.

Making the inner diameter D of the gas chamber 11B larger than the inner diameter d of the cylinder 5 enables a reduction in the stroke of sliding movement of the free piston 9, which is caused by the extension and contraction of the piston rod 20. Accordingly, the axial dimension of the gas chamber 11B can be reduced. In addition, the central opening 4A of the separator 4 and the recess 9A of the free piston 9 form a relief space for the piston rod 20 and the piston nut 21, which project below the piston 19. Therefore, the axial space efficiency can be increased. As a result, the axial dimension of the hydraulic shock absorber 1 can be reduced, and it is possible to achieve space saving and to widen the range of vehicle types to which the hydraulic shock absorber 1 is applicable.

Although a free piston is used as the partition in the foregoing embodiment, it should be noted that the present invention is not necessarily limited thereto. The partition in the present invention may take any form that prevents gas from flowing out into the hydraulic fluid chamber and that allows the volumetric capacity of the gas chamber to vary, e.g. a rubber or metal bellows.

What is claimed is:

1. A hydraulic shock absorber comprising:
a cylinder having a hydraulic fluid sealed therein;
a piston slidably fitted in said cylinder, said piston dividing an interior of said cylinder into a first chamber and a second chamber;
a piston rod connected at one end thereof to said piston to form a piston assembly, the other end of said piston rod extending through said second chamber to an outside of said cylinder;
a damping force generating mechanism that generates damping force by controlling flow of hydraulic fluid induced by sliding movement of said piston in said cylinder; and
a reservoir tank having a hydraulic fluid chamber communicably connected to the interior of said cylinder, said reservoir tank further having a gas chamber divided from said hydraulic fluid chamber by a partition;
wherein said reservoir tank is formed as a subassembled reservoir cartridge provided in a cylindrical casing;
said cylinder and said reservoir cartridge being inserted in a base shell having a cylindrical shape, one end of which is closed;
wherein a first hydraulic fluid passage is formed between an outer periphery of said reservoir cartridge and said base shell, said first hydraulic fluid passage communicating with the first chamber of said cylinder, and a second hydraulic fluid passage is formed between an outer periphery of said cylinder and said base shell, said second hydraulic fluid passage communicating with the second chamber of said cylinder, said first hydraulic fluid passage and said second hydraulic fluid passage being cut off from each other by a separator, said reservoir cartridge and said cylinder being fixed together in an axial direction by securing a seal member to an open end of said base shell, and said damping force generating mechanism being attached to an outside of said base shell, said damping force generating mechanism and said cylinder being communicated with each other through said first hydraulic fluid passage and said second hydraulic fluid passage.

2. A hydraulic shock absorber according to claim 1, wherein the partition of said reservoir tank is a free piston.

3. A hydraulic shock absorber according to claim 2, wherein the casing constituting said reservoir tank has an inner diameter larger than that of said cylinder.

4. A hydraulic shock absorber according to claim 1, wherein said separator connects said cylinder and said reservoir cartridge to each other.

5. A hydraulic shock absorber according to claim 4, wherein said separator is in a circular cylindrical shape and has therein a relief space for a projecting portion of said piston assembly.

6. A hydraulic shock absorber according to claim 2, wherein said separator is in a circular cylindrical shape and has therein a relief space for a projecting portion of said piston assembly, and said free piston is provided with a recess communicating with said relief space.
